(19) United States
(12) Patent Application Publication
(10) Pub. No.: US 2006/0085473 A1
(43) Pub. Date: Apr. 20, 2006

(54) Method and system for business process super-transaction

(76) Inventors: Frederik Thormaehlen, Mannheim (DE); Rene Lieb, Cham (CH)

Correspondence Address: KENYON & KENYON, 1500 K STREET N.W., WASHINGTON, DC, 20005, US

(21) Appl. No.: 11/150,141

(22) Filed: Jun. 13, 2005

Related U.S. Application Data
(60) Provisional application No. 60/618,183, filed on Oct. 14, 2004.

(51) Int. Cl. G06F 7/00

(52) U.S. Cl. 707/102

(57) ABSTRACT

Embodiments of the present invention relate to a process-oriented extendable “super-transaction” able to handle multiple business objects in an integrated manner. The embodiments may comprise computer-executable instructions to build objects associated with a business process, and to link the objects using pointers. The linkages enable multiple objects of a business process to be handled in an automated, streamlined flow without manual tracking of objects.

This application claims the benefit under 35 USC § 119(e) of U.S. provisional application 60/618,183, filed Oct. 14, 2004 and fully incorporated herein by reference.

### BACKGROUND OF THE INVENTION

Business processes may involve the manipulation of business software objects. An object may represent a quantum of data or a grouping of related data on a database, and provide functionality via object interfaces to retrieve and perform operations on the data. More specifically, an object may be implemented at least in part as a plurality of entries in tables of a relational database.

In known computer systems, manual manipulation of business objects pursuant to a business process can be laborious and error-prone. The process may entail the creation and manipulation of multiple business objects. However, because the creation and manipulation of the business objects in such known systems typically involves handling a single object at a time, each in a separate transaction, and then manually tracking the relationship of each object with other objects of the process, errors are frequent.

An illustrative example occurs in banks. In a bank, opening a new bank customer account and servicing it thereafter may be viewed as a business process. As part of the business process, a customer advisor in a front office may manipulate a number of business objects by means of a user interface. The customer advisor might begin by creating a new business object to represent a new customer of the bank. To create the customer business object, the customer advisor may invoke a transaction on a computer system, enter information descriptive of the customer via a user interface, and then cause the user interface to perform operations to store the information on a computer database, and to assign the customer a unique identifier.

Next, the customer advisor may invoke a separate transaction to create a customer account object. This step may involve manually transferring the customer identifier to the transaction, for example by writing the customer identifier down on paper and then entering it via a user interface into the transaction for creating a customer account object. As with the creation of the customer object, creation of the account object may involve the entering by the customer advisor of information relating to the customer's account, and storing of the information on a database. A unique account number identifying the customer account may be automatically generated.

Then, the customer advisor could invoke still another separate transaction to create a credit line for the customer. This transaction may require the customer advisor to enter the customer identifier and the account number generated previously. Again, this information may need to be manually transferred into the transaction for creating a credit line, by writing the information down on paper and then entering it via a user interface.

Clearly, the manual steps associated with a business process as described above are time-consuming, laborious and invite error. Accordingly, an approach is called for which addresses such disadvantages.

### BRIEF DESCRIPTION OF THE DRAWINGS

FIG. 1 illustrates multiple iterations of a process according to embodiments of the present invention;

FIG. 2 shows a method flow according to embodiments of the present invention;

FIG. 3 shows a network environment wherein embodiments of the present invention may find advantageous application; and

FIG. 4 shows a computer system for implementing embodiments of the present invention.

### DETAILED DESCRIPTION

Embodiments of the present invention relate to a process-oriented “super-transaction” able to handle multiple business objects in an integrated manner. The embodiments may comprise computer-executable instructions to build objects associated with a business process, and to link the objects using pointers. The linkages enable multiple objects of a business process to be handled in an automated, streamlined flow without manual tracking of objects.

Embodiments of the invention may include instructions for implementing a design stage and a run-time stage. During the design stage, phases of the business process may be defined. A phase may comprise one or more steps. The definition may be performed, for example, by executing a user dialog through a user interface. Execution of the design stage may include the creation of a configuration file that contains a definition of phases and steps forming a business process. Each step may have a corresponding application program and an object associated with it.

The configuration file produced by the design stage may subsequently be input to the run-time stage. The run-time stage may build the actual business objects needed to implement the phases and steps of the business process defined in the design stage.

The run-time stage may be viewed as comprising multiple software levels. A top level may maintain a run-time context to hold run-time configuration values. The run-time context may be “persistent,” in that it preserves run-time configuration values at a break point in an execution of the run-time stage, so that an execution of the run-time stage may be interrupted and then resumed without having to re-enter values previously entered.

A second software level, below the top level, may perform operations to build an object pointer. The object pointer may comprise minimal identifying information for an object, sufficient to retrieve the object from a storage medium, but little else. Object pointers of this kind may provide for extendability of a business process. That is, because the object pointers are simple and generic, they may be easily and efficiently created and manipulated at the top and second levels. On the other hand, the object pointers enable the processing of more complex and customized objects at lower levels that can be added on to extend a business process, as described in more detail further on.

In a plurality of iterations of the run-time stage, a corresponding plurality of object pointers may be formed at the second software level, each pointing to an object corresponding to a process step. The pointers may be held by the run-time context, enabling the objects created during the run-time stage to be handled in a process-oriented “super-transaction” as noted above and described in more detail further on.

Third and fourth software levels below the second level may perform operations to create business objects. The third level may more particularly be a lava level. As is known, Java is a programming language based on an object-oriented programming model and designed for use in a distributed environment such as a network. Java can be used to create complete applications that may run on a single computer or be distributed among servers and clients in a network. According to embodiments of the present invention, lava applications on the third software level may perform function calls to software on the fourth software level.

The fourth level may comprise APIs (application programming interfaces) responsive to the function calls of an application of the third level. In embodiments, the APIs may be standard object-oriented APIs of the R/3® system designed by SAP Aktiengesellschaft. In response to the function calls via the APIs, standard functions of an installed R/3® system may execute to perform the low-level work of filling entries in tables of a relational database, where, as described above, the table entries collectively correspond to a business object.

An illustrative example is given in the following. Returning to the bank setting mentioned earlier, assume that a bank has a computer system configured according to embodiments of the present invention. That is, in a design stage, in one or more interactive dialog sessions with a user interface, the user has defined a business process comprising a single phase that includes creation of a customer object, followed by the creation of a customer account object, then the creation of a standing order object (a “standing order” could be, e.g., a request to a bank to make an automated periodic payment to an account), and finally the creation of a credit card object. The objects to be created will all be related to each other in that they will support the providing of services to a particular given customer. As noted earlier, an output of the design stage is a configuration file stored on a database of the computer system.

Next, assume a customer enters the bank and is assisted by a customer advisor to open a new account. To open the new account, the advisor invokes a run-time stage according to embodiments of the present invention. The run-time stage reads the configuration file created in the design stage. As noted, the configuration file specifies that the first step of the business process is the creation of a customer object. Like the design stage, the run-time stage might present a user interface for performing a user dialog. A display of the interface might present a description of the step currently being performed, for example, “Create Customer Object”, or the like. The interface may further present fields for entering parameters relating to the object being created. For creating a customer object, the parameters might include customer information, such as a customer name and address. The advisor may proceed to enter the customer information and other parameters.

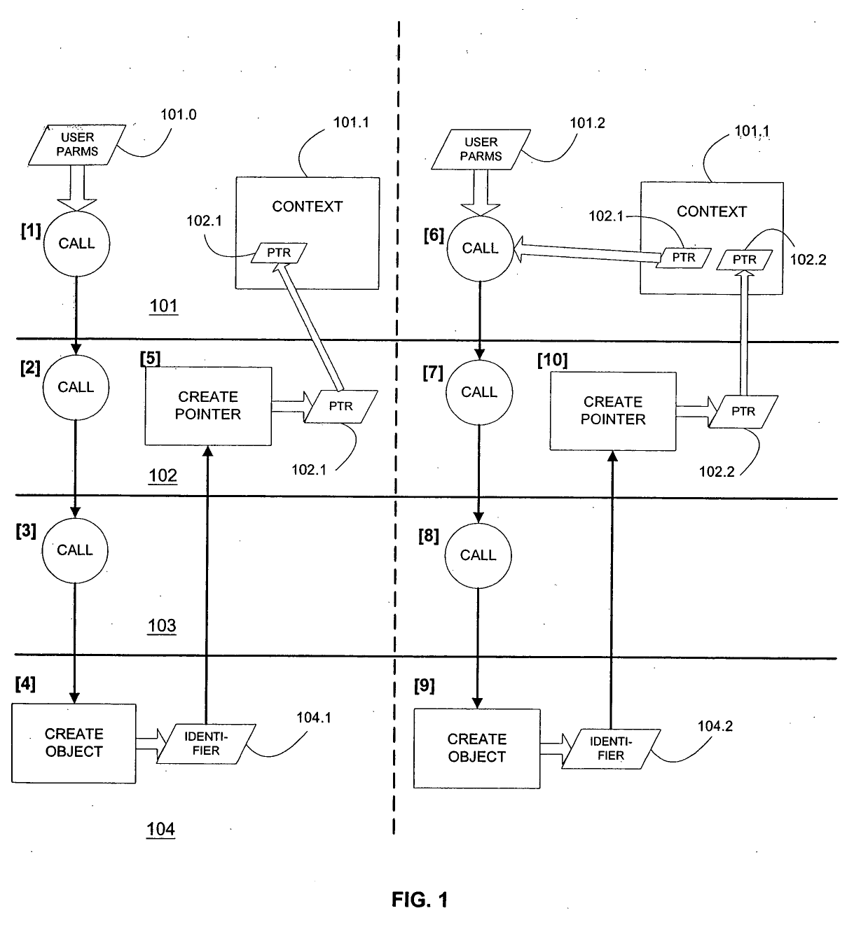

Referring now to FIG. 1, the parameters 101.0 may be passed to a top or run-time level 101 of the run-time stage. The run-time level 101 may maintain a context 101.1. The context 101.1 may be persistent on a database (not shown). For example, if a user wants to pause or interrupt an execution of the run-time stage and continue at another time, a current state of the context 101.1 may be saved to a database. When execution of the run-time stage is later resumed, the context may be read from the database and the run-time stage can continue from the point at which it was interrupted.

The run-time level may perform operations including [1] calling software of a second or linkage software level 102, and passing it the user-entered parameters 101.0. The linkage level 102 may comprise software to create an object pointer for objects created by third and fourth levels below the linkage level 102. At this point in the example under discussion, an object has yet to be created, so the linkage level may simply [2] call software of the third or network application level 103 and pass the user-entered parameters 101.0 to the network application level 103.

As noted above, the network application level 103 may comprise Java applications. An application corresponding to the process step as defined by the configuration file may [3] issue function calls via standard business APIs to pre-installed SAP R/3® functions of a fourth or function level 104, and pass the functions the user-entered parameters 101.0. Based at least in part on the values of user-entered parameters 101.0 passed by the Java application, the functions may [4] create the customer business object and store it on a database. The functions may further generate a unique identifier 104.1 for the newly created customer object.

The linkage level 102 may then be returned to. The unique identifier 104.1 may be passed to the linkage level 102. Software at the linkage level 102 may [5] create a pointer 102.1 for the newly created customer object at least in part using the unique identifier 104.1. The pointer 102.1 may itself be an object that has attributes. In particular, creating the pointer 102.1 may include assigning a “key” attribute and a “type” attribute to the pointer object 102.1. The key attribute may be the unique identifier 104.1 for the customer object generated at the function level 104. The type attribute may be, for example, “customer,” to indicate that the pointer object 102.1 points to a customer object. The key attribute and the type attribute may be all the information that is needed to retrieve the newly created customer object from the database on which it is stored.

The linkage level 102 may then pass the pointer object 102.1 to the run-time level 101, which saves the pointer object 102.1 in the context 101.1.

At this point, the customer advisor in the bank may see a display in the user interface indicating that the new customer object had been successfully created. For example, the message “Customer 4711 has been successfully created” could be displayed. In contrast to what would have been required in the past, however, the customer advisor need not write down the identifier of the customer object in order to proceed with the next step of the process. Instead, because the pointer object 102.1 preserves this information in the persistent context 101.1, the customer object identifying information is always available, even if the process is interrupted.

A next iteration of the run-time stage may then be performed. The next iteration may correspond to the next step of the business process, in this example, the creation of a customer account object. The customer advisor may invoke the next iteration from the user interface. The user interface might, for example, present a display indicating the step being performed, such as “Create Customer Account for Customer 4711.” The advisor may enter values relating to the “Create Customer Account for Customer 4711” step via the interface. The values might include, for example, a type, a purpose and a currency of the account. The run-time level 101 may [6] call the linkage level 102 and pass the linkage level 102 the pointer object 102.1 created in the previous iteration and the user-entered parameters 101.2 relating to the customer account object. The linkage level 102 may [7] call the network application level 103 and pass it the pointer object 102.1 and the parameters 101.2.

The network application level 103 may [8] call the function level 104 and pass it the pointer object 102.1 and the parameters 101.2. The function level 104 may [9] create the customer account object, store it on a database, and generate a unique identifier 104.2 for the newly created customer account object. In particular, the function level 104 may obtain information needed to create the customer account object by using the pointer object 102.1 to access data of the customer object created in the previous iteration.

The linkage level 102 may then be returned to. The unique identifier 104.2 created by the function level 104 for the account object may be passed to the linkage level 102. The linkage level 102 may [10] create a pointer object 102.2 for the newly created customer account object, and assign the unique identifier 104.2 as the key attribute for the pointer object 102.2, and the attribute “account” as the type attribute for the pointer 102.2. The linkage level 102 may then pass the pointer object 102.2 to the run-time level 101, which saves the pointer object 102.2 along with the pointer object 102.1 (corresponding to the customer object created in the previous iteration) in the context 101.1.

Third and fourth iterations of the run-time stage may follow, as determined by the process definition of the design phase. As noted above, in this example the process definition called for the creation of a standing order object and of a credit card object in the third and fourth process steps, respectively. Accordingly, the third and fourth iterations may generate these objects. As described for the first and second iterations, at the linkage level a pointer object may be created for each new object, and passed to the run-time level to be stored in the context. The pointer objects created in earlier iterations may be passed to subsequent iterations and used in the creation of objects in those subsequent iterations. User-entered parameters could be also processed in each of the iterations.

Thus, more specifically, in a third iteration to create a standing order object, pointer objects 102.1 and 102.2 may be read out from the run-time level context 101.1 and passed to the function level 104. The pointer objects 102.1 and 102.2 would enable the function level 104 to access data in the customer object and account object created earlier, and this data could be used in the creation of the standing order object. Similarly, in a fourth iteration to create a credit card object, pointer objects 102.1 and 102.2, and a pointer object for the standing order object created in the third iteration, may be read out from the run-time level context 101.1 and passed to the function level 104. The pointer objects would enable the function level 104 to access data in the customer object, account object and standing order object created earlier, and this data could be used in the creation of the credit card object. Thus, iterations of the run-time stage linked by the object pointers implement an integrated “super-transaction” that frees a user from the laborious and error prone tasks of prior arrangements. Moreover, while a comparatively simple example has been described for purposes of illustration, it may be appreciated that the basic model described may be applied in situations involving much more complex business processes, many business objects and many users.

For instance, greater complexity in a bank account may readily be envisioned. A customer bank account may, for example, be viewed as a hierarchical tree structure. A single customer at a top level may be associated with several customer accounts. A single customer account at a level below the customer level may in turn be associated with several standing orders and several credit cards. Creating and managing objects representing the latter at each level may require referencing objects at a higher level. In a super-transaction according to embodiments of the present invention, the referencing is integrated and automated using the software levels and pointer objects, freeing a user from corresponding manual efforts.

It may further be appreciated that embodiments of the present invention provide for easy extendability of business processes. That is, a given user can create customized or specialized business objects according to the user's needs, but the details of the business objects are handled by the third and fourth software levels. At the first and second software levels, the underlying business objects can be represented by abstract, generic pointers, and easily linked by the pointers to build and extend business processes.

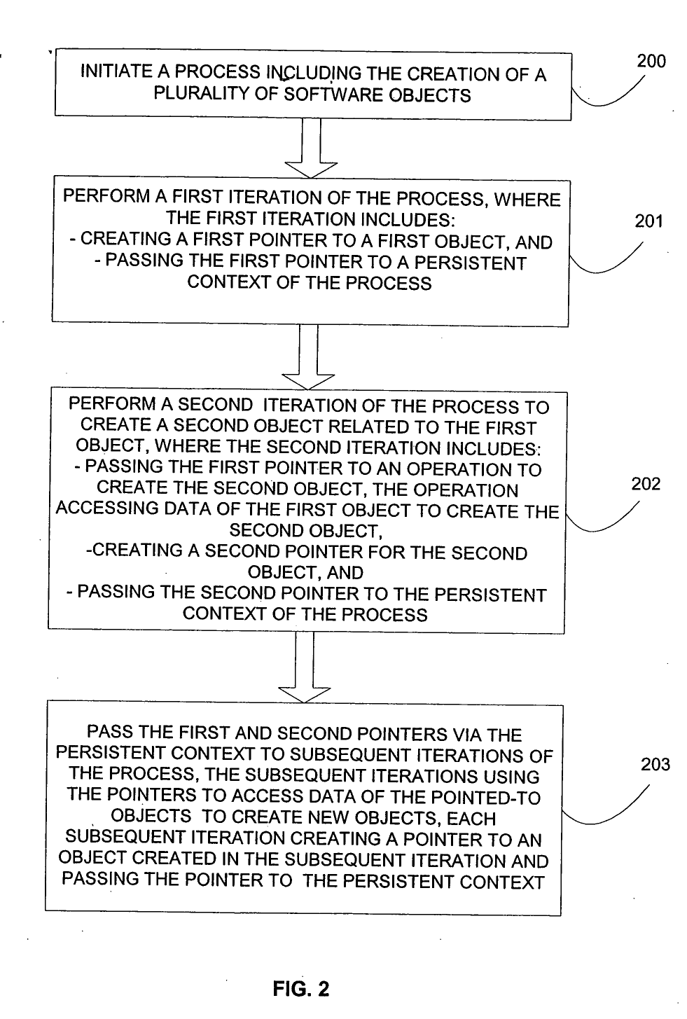

FIG. 2 shows a method flow according to embodiments of the present invention. As shown in block 200, the method may comprise initiating a process that includes a creation of a plurality of software objects.

As shown in block 201, the method may further comprise performing a first iteration of the process to create a first object, where the first iteration includes: creating a first pointer to the first object; and passing the first pointer to a persistent context of the process.

The method may further comprise performing a second iteration to build a second object related to the first object, as shown in block 202. The second iteration may include: passing the first pointer from the persistent context to an operation that creates a second object related to the first object, the operation accessing data of the first object using the first pointer to create the second object; creating a second pointer for the second object; and passing the second pointer to the persistent context of the process.

As shown in block 203, the method may further comprise passing the first and second pointers via the persistent context to subsequent iterations of the process, the subsequent iterations using the pointers to access data of the pointed-to objects to create new objects, each subsequent iteration creating a pointer to an object created in the subsequent iteration and passing the pointer to the persistent context.

Components of the present invention could execute on one or more of a plurality of hardware platforms in a client-server environment. The environment may include client machines to handle front-end processing (e.g., user interfaces), application servers to process application logic, and database servers to handle database access.

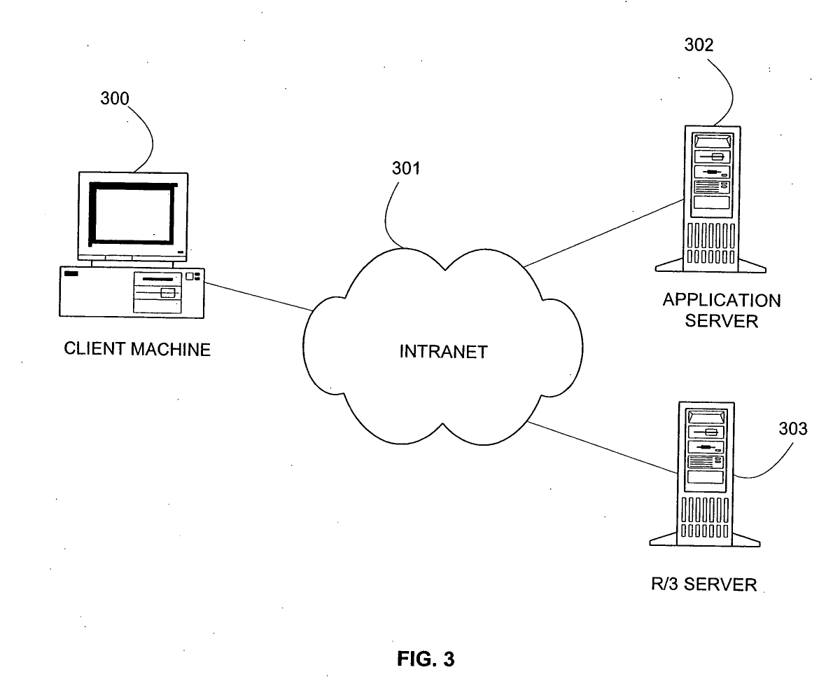

More specifically, embodiments of the present invention may execute on a network such as an intranet. FIG. 3 illustrates a client/server arrangement including an intranet wherein embodiments of the present invention might advantageously be used. A user could invoke processes according to the embodiments via a client browser that executes on a client machine 300. The client machine 300 may be coupled to an intranet 301. Software levels 101, 102 and 103 as described above may execute on an application server 302, such as a J2EE (Java) application server. Server 302 may be coupled to the intranet 301 and be responsive to requests from the client machine 300 received via the intranet 301. Software level 104 may execute on an SAP R/3® server 303 that executes ABAP-based software. Server 303 may be coupled to the intranet 301 and be responsive to function calls by applications executing on the application server 302 received via the intranet 301. An intranet portal may provide links to the client browser, whereby the user can selectively activate process steps. For example, the links could include the options to selectively activate the run-time stage to “Create Customer Object” or to “Create Customer Account Object” as described above, or to activate other phases or steps of a business process.

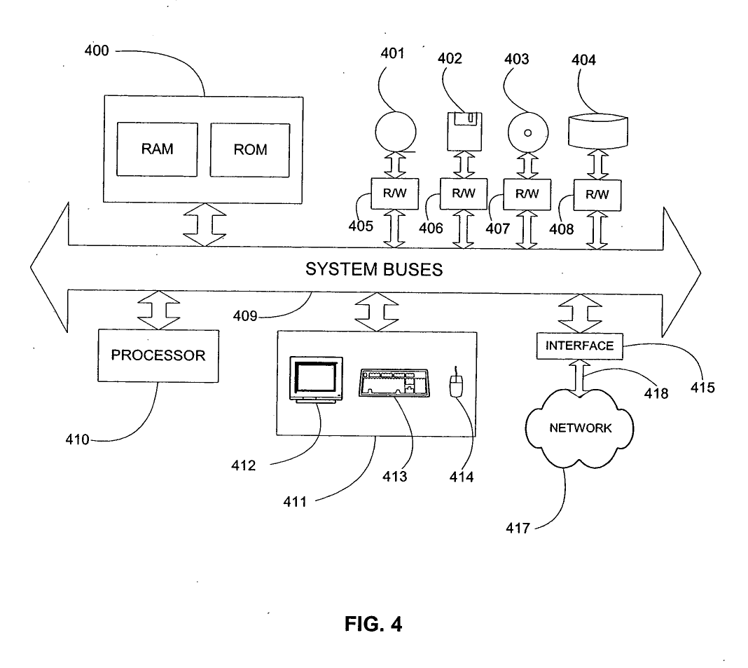

FIG. 4 shows a high-level representation of a computer system for implementing embodiments of the present invention, such as might be realized by a variety of known and commercially available hardware and software elements. The system may comprise a memory 400 including ROM and RAM, a processor 410 and a user interface 411 comprising a display device 412, a keyboard 413 and a mouse 414. Elements may communicate via system buses 409. The system may further comprise a network 417 connected by a network medium 418 and a network interface 415.

A computer program or collection of programs comprising computer-executable instructions according to embodiments of the present invention may be stored and transported on machine-readable media such as magnetic tape 401, diskette 402, CD-ROM 403 and fixed disk 404. The computer-executable instructions may be retrieved from the machine-readable media 401-404 using their respective reading devices 405-408 into memory 400, and executed by a processor 410. The computer-executable instructions may be distributed across a plurality of media, such as on physically separate storage devices respectively associated with physically separate computer systems that may communicate via a network. The functionality disclosed hereinabove may find specific implementations in a variety of forms, which are considered to be within the abilities of those of ordinary skill in the pertinent art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
performing a first iteration of a process to create a first object, the first iteration including:
creating a first pointer to the first object; and
passing the first pointer to a persistent context of the process; and
performing a second iteration to build a second object related to the first object, the second iteration including:
passing the first pointer from the persistent context to an operation to create a second object related to the first object, the operation accessing data of the first object using the first pointer to create the second object.

2. The method of claim 1, the second iteration further comprising:
creating a second pointer for the second object; and
passing the second pointer to the persistent context of the process.

3. The method of claim 2, further comprising passing the first and second pointers via the persistent context to a subsequent iteration of the process, the subsequent iteration using the pointers to access data of the pointed-to objects to create a new object.

4. A method for performing a computerized transaction, comprising:
creating a first object and storing the first object on a database;
creating a pointer to the first object;
saving the pointer in a run-time data storage area; and
creating a second object at least in part by reading the pointer from the run-time data storage area and using the pointer to access data of the first object on the database.

5. The method of claim 4, wherein the pointer comprises an identifier for the first object.

6. The method of claim 4, wherein the pointer comprises an attribute of the first object.

7. The method of claim 4, wherein the first object is stored on a relational database.

8. The method of claim 4, further comprising interrupting the transaction and storing a current state of the run-time storage area on a database.

9. The method of claim 8, further comprising resuming the transaction and reading the current state of the run-time storage area from the database to resume to transaction where it was interrupted.

10. A network comprising:
a first server to execute a first part of a transaction, the first part of the transaction including creating an object pointer and maintaining a persistent run-time context, the context to hold the object pointer; and
a second server to execute a second part of the transaction, the second part of the transaction including creating an object in response to parameters passed from the first part of the transaction, and passing an identifier of a created object to the first part of the transaction, the first part of the transaction creating a pointer to the created object using at least in part the identifier.

11. The network of claim 10, wherein the first part of the transaction includes executing a Java application.

12. The network of claim 10, wherein the second part of the transaction includes executing ABAP software.

13. A machine-readable medium comprising computer-executable instructions to perform a method comprising:
performing a first iteration of a process to create a first object, the first iteration including:
creating a first pointer to the first object; and
passing the first pointer to a persistent context of the process; and
performing a second iteration to build a second object related to the first object, the second iteration including:
passing the first pointer from the persistent context to an operation to create a second object related to the first object, the operation accessing data of the first object using the first pointer to create the second object.

14. The machine-readable medium of claim 13, the second iteration further comprising:
creating a second pointer for the second object; and
passing the second pointer to the persistent context of the process.

15. The machine-readable medium of claim 13, the second iteration further comprising passing the first and second pointers via the persistent context to a subsequent iteration of the process, the subsequent iteration using the pointers to access data of the pointed-to objects to create a new object.

16. A machine-readable medium comprising computer-executable instructions to perform a method comprising:
creating a first object and storing the first object on a database;
creating a pointer to the first object;
saving the first-object pointer in a run-time data storage area; and
creating a second object at least in part by reading the first-object pointer from the run-time data storage area and using the first-object pointer to access data of the first object on the database.

17. The machine-readable medium of claim 16, wherein the pointer comprises an identifier for the first object.

18. The machine-readable medium of claim 16, wherein the pointer comprises an attribute of the first object.
